(19) United States
(12) Patent Application Publication
(10) Pub. No.: US 2010/0069597 A1
(43) Pub. Date: Mar. 18, 2010

(54) FINE-PARTICLED POLYMER DISPERSIONS CONTAINING STARCH

(75) Inventors: Rajan Venkatesh, Mannheim (DE); Roland Ettl, Mannheim (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: BASF SE, Ludwigshafen (DE)

(21) Appl. No.: 12/513,376

(22) PCT Filed: Nov. 5, 2007
(86) PCT No.: PCT/EP07/61854

§ 371 Date: May 4, 2009

(30) Foreign Application Priority Data
Nov. 10, 2006 (EP) 06023434.1

(51) Int. Cl. C08F 251/00

(52) U.S. Cl. 527/312

(57) ABSTRACT

Finely divided, starch-containing polymer dispersions which are obtainable by free radical emulsion copolymerization of
(a) from 30 to 60% by weight of at least one optionally substituted styrene, acrylonitrile and/or methacrylonitrile,
(b) from 5 to 50% by weight of at least one C₁-C₁₂-alkyl acrylate and/or C₁-C₁₂-alkyl methacrylate,
(c) from 5 to 30% by weight of at least one olefin,
(d) from 0 to 10% by weight of at least one other ethylenically unsaturated copolymerizable monomer and
(e) from 15 to 35% by weight of a degraded starch,
   the sum (a)+(b)+(c)+(d)+(e) being 100% and being based on the total solids content, in an aqueous medium in the presence of at least one redox initiator, processes for the preparation of the aqueous polymer dispersions by free radical emulsion copolymerization of the components (a) to (e) in an aqueous medium in the presence of a redox initiator and use of the finely divided, starch-containing polymer dispersions thus obtainable as sizes for paper, board and cardboard.

The invention relates to finely divided, starch-containing polymer dispersions which are obtainable by emulsion polymerization of ethylenically unsaturated monomers in the presence of at least one redox initiator and starch, processes for the preparation of the dispersions and their use as sizes for paper.

EP-B-0 276 770 and EP-B-0 257 412 disclose sizes based on finely divided, aqueous dispersions which are obtainable by copolymerization of ethylenically unsaturated monomers, such as acrylonitrile and (meth)acrylates and, if appropriate, up to 10% by weight of other monomers, such as styrene, by an emulsion polymerization method in the presence of initiators comprising peroxide groups, in particular of redox initiators, and degraded starch.

EP-A-0 307 812 describes sizes, inter alia also finely divided, aqueous, cationic polymer dispersions which are obtainable by emulsion copolymerization of (i) acrylonitrile, methacrylonitrile, methyl methacrylate and/or styrene, (ii) at least one acrylate or methacrylate of in each case monohydric, saturated C₃-C₈-alcohols, vinyl acetate, vinyl propionate and/or 1,3-butadiene and, if appropriate, (iii) other ethylenically unsaturated monomers in an aqueous solution of a degraded cationic starch in the presence of a redox initiator.

EP-A-0 536 597 discloses aqueous polymer dispersions which are obtainable by free radical emulsion copolymerization of unsaturated monomers in the presence of a starch degradation product. The starch degradation product forms as a result of hydrolysis in the aqueous phase and has complete solubility in water at room temperature at a weight average molecular weight M_{w} of from 2500 to 25 000. Preferably used monomer mixtures are mixtures of styrene and (meth)acrylates of monohydric, saturated C₁-C₁₂-alcohols in combination with up to 10% by weight of acrylic acid and/or methacrylic acid. The dispersions are used as binder, adhesive, size for fibers or for the production of coatings.

EP-B-1 056 783 likewise discloses aqueous, finely divided polymer dispersions which are used for the surface sizing of paper, board and cardboard. The dispersions are obtainable by free radical emulsion polymerization of ethylenically unsaturated monomers in the presence of degraded starch having a number average molecular weight Mₙ of from 500 to 10 000. The monomer mixtures consist of (i) at least one optionally substituted styrene, (ii) at least one C₁-C₄-alkyl (meth)acrylate and (iii) if appropriate up to 10% by weight of other ethylenically unsaturated monomers. The polymerization is effected in the presence of a graft-linking, water-soluble redox system.

WO-A-00/23479 likewise discloses sizes which are obtainable by free radical emulsion copolymerization of a monomer mixture (A) comprising, for example, (i) at least one optionally substituted styrene, (ii) if appropriate at least one C₄-C₁₂-alkyl(meth)acrylate and (iii) at least one monomer from the group consisting of methyl acrylate, ethyl acrylate and propyl acrylate in the presence of (B) starch having an average molecular weight of 1000 or greater, the weight ratio (A):(B) being from 0.6:1 to 1.7:1, which size is free of emulsifiers or surface-active agents having a molecular weight of less than 1000 and comprises virtually no monomers having acid groups incorporated in the form of polymerized units. Cationic starch, in particular oxidized cationic corn starch, is preferred as component (B) of the size, and component (A) preferably consists of a mixture of styrene, n-butyl acrylate and methyl acrylate.

EP-B-1 165 642 discloses a further polymer dispersion and a process for its preparation, a monomer mixture which comprises at least one vinyl monomer being polymerized in an aqueous solution of a starch which has a degree of substitution (DS), based on the cationic or anionic substituents, of from 0.01 to 1 and, in cationized and/or anionized form, has an intrinsic viscosity of >1.0 dl/g. The starch used in the polymerization is either non-degraded or only slightly oxidized but in no case enzymatically degraded. The resulting polymer has a film formation temperature of from −50 to +200° C. It is composed, for example, of acrylates and styrene and, if appropriate, acrylonitrile. The polymer dispersions which can be prepared in this manner are used as sizes for paper.

According to the process disclosed in WO-A-02/14393, sizes and coating materials for paper are prepared by free radical emulsion polymerization of a monomer mixture comprising (i) at least one (meth)acrylate of monohydric, saturated C₃-C₈-alcohols and (ii) one or more further ethylenically unsaturated monomers in the presence of starch and/or of a starch derivative, monomers and initiator being fed continuously to an aqueous starch solution and the initiator being metered in two portions under specially defined conditions.

Starch-based polymers which can be prepared by polymerization of (i) from 35 to 65% by weight of an ethylenically unsaturated monomer which is free of carboxyl groups, (ii) from 35 to 65% by weight of an ethylenically unsaturated mono- or dicarboxylic acid or salts thereof and (iii) from 0 to 15% by weight of another ethylenically unsaturated monomer in an aqueous medium in the presence of starch are also known, cf. WO-A-2004/078807. The starch used may be a natural starch, dextrin or a starch derivative. The resulting polymers are water-soluble. They are used as sizes for paper, board and cardboard.

The prior German application 10 2005 030 787.6 discloses finely divided, starch-containing polymer dispersions which are obtainable by the free radical emulsion copolymerization of ethylenically unsaturated monomers in the presence of at least one redox initiator and starch,
(a) from 45 to 55% by weight of at least one optionally substituted styrene, methyl methacrylate, acrylonitrile and/or methacrylonitrile,
(b) from 15 to 29% by weight of at least one C₁-C₁₂-alkyl acrylate and/or one C₂-C₁₂-alkyl methacrylate and
(c) from 0 to 10% by weight of at least one other ethylenically unsaturated copolymerizable monomer

being used as ethylenically unsaturated monomers and
(d) from 15 to 35% by weight of a degraded cationized starch which has a molar mass M_{w} of from 1000 to 65 000,

being used as starch,

the sum (a)+(b)+(c)+(d) being 100% and being based on the total solids content.

Furthermore, the prior German application 10 2005 030 789.2 discloses finely divided, starch-containing polymer dispersions which are obtainable by free radical emulsion copolymerization of ethylenically unsaturated monomers in the presence of at least one redox initiator and starch,
(a) from 25 to 50% by weight of at least one optionally substituted styrene, methyl methacrylate, acrylonitrile and/or methacrylonitrile,
(b) from 1 to 49% by weight of at least one C₁-C₄-alkyl acrylate and/or one C₂-C₄-alkyl methacrylate,
(c) from 1 to 49% by weight of at least one C₅-C₂₂-alkyl acrylate and/or one C₅-C₂₂-alkyl methacrylate and
(d) from 0 to 10% by weight of at least one other ethylenically unsaturated copolymerizable monomer

being used as ethylenically unsaturated monomers and
(e) from 15 to 40% by weight of at least one degraded starch which has a molar mass M_{w} of from 1000 to 65 000,

being used as the starch,

the sum (a)+(b)+(c)+(d)+(e) being 100% and being based on the total solids content. The polymerization is carried out in the presence of at least 0.01% by weight, based on the monomers used, of at least one polymerization regulator.

The prior EP application 06120685.0 discloses aqueous polymer dispersions which are obtainable by free radical aqueous emulsion polymerization of ethylenically unsaturated monomers in the presence of at least one dispersant, at least one free radical initiator and at least one water-soluble macromolecular host compound, from 1 to 50% by weight of an alkene having 4 to 40 carbon atoms (monomer A) and from 50 to 99% by weight of an ether based on an α,β-monoethylenically unsaturated mono- or dicarboxylic acid having 3 to 6 carbon atoms and on an alkanol having 1 to 12 carbon atoms (monomer B) being used for the emulsion polymerization, at least 50% by weight of the total amount of macromolecular host compound, at least 50% by weight of the total amount of monomer A and optionally up to 10% by weight of the total amount of monomer B being initially taken in the polymerization vessel before initiation of the polymerization and any residual amounts of macromolecular host compound and/or of monomer A and monomer B or the total amount of monomer B being fed to the polymerization vessel under polymerization conditions. The aqueous dispersions thus obtainable are used for the preparation of adhesives, sealing compounds, plastic renders, paper coating slips, fiber webs, paints and coating materials for organic substrates and for modifying mineral binders.

The object of the invention is to provide further starch-containing polymer dispersions which have improved performance characteristics compared with the known, comparable polymer dispersions. They should, for example, have an improved sizing effect and printability, in particular improved inkjet printability and toner adhesion.

The object is achieved, according to the invention, by finely divided, starch-containing polymer dispersions which are obtainable by free radical emulsion copolymerization of ethylenically unsaturated monomers in the presence of at least one redox initiator and starch, if
(a) from 30 to 60% by weight of at least one optionally substituted styrene, acrylonitrile and/or methacrylonitrile,
(b) from 5 to 50% by weight of at least one C₁-C₁₂-alkyl acrylate and/or C₁-C₁₂-alkyl methacrylate,
(c) from 5 to 30% by weight of at least one olefin,
(d) from 0 to 10% by weight of at least one other ethylenically unsaturated copolymerizable monomer and
(e) from 15 to 35% by weight of a degraded starch

are used as ethylenically unsaturated monomers,

the sum (a)+(b)+(c)+(d)+(e) being 100% and being based on the total solids content.

Preferred polymer dispersions are those which are obtainable by free radical emulsion copolymerization of
(a) from 35 to 50% by weight of at least one optionally substituted styrene, acrylonitrile and/or methacrylonitrile,
(b) from 15 to 30% by weight of at least one C₁-C₁₂-alkyl acrylate and/or one C₁-C₁₂-alkyl methacrylate,
(c) from 10 to 20% by weight of a C₈- to C₂₄-olefin,
(d) from 0 to 5% by weight of at least one other ethylenically unsaturated copolymerizable monomer and
(e) from 20 to 30% by weight of a degraded anionic, cationic or amphoteric starch,

the sum (a)+(b)+(c)+(d)+(e) being 100% and being based on the total solids content, in the presence of at least one redox initiator.

Particularly preferred finely divided, starch-containing polymer dispersions are those which are obtainable by free radical emulsion copolymerization of
(a) from 35 to 50% by weight of styrene,
(b) from 15 to 30% by weight of at least one C₄-C₆-alkyl acrylate and/or one C₄-C₆-alkyl methacrylate,
(c) from 10 to 20% by weight of at least one C₁₀- to C₁₈-olefin,
(d) from 0 to 5% by weight of at least one other ethylenically unsaturated copolymerizable monomer and
(e) from 20 to 30% by weight of a degraded anionic, cationic, amphoteric or natural starch,

the sum (a)+(b)+(c)+(d)+(e) being 100% and being based on the total solids content.

The degraded starch has, for example, a molar mass M_{w} of from 1000 to 65 000, in particular from 2500 to 35 000.

Ethylenically unsaturated monomers of the group (a) are, for example, styrene, substituted styrenes, e.g. styrenes halogenated on the ring, such as chlorostyrene, or C₁- to C₄-alkyl-substituted styrenes, such as vinyltoluene or α-methylstyrene.

Suitable monomers of group (b) are, for example, all esters of acrylic acid and of methacrylic acid which are derived from monohydric C₁- to C₁₂-alcohols, such as methyl acrylate, methyl methacrylate, ethyl acrylate, ethyl methacrylate, n-propyl acrylate, n-propyl methacrylate, isopropyl acrylate, isopropyl methacrylate, n-butyl acrylate, n-butyl methacrylate, isobutyl acrylate, isobutyl methacrylate, tert-butyl acrylate, tert-butyl methacrylate, sec-butyl acrylate, sec-butyl methacrylate, n-pentyl acrylate, n-pentyl methacrylate, neopentyl acrylate, neopentyl methacrylate, cyclohexyl acrylate, cyclohexyl methacrylate, 2-hexyl acrylate, 2-hexyl methacrylate, 2-ethylhexyl acrylate, 2-ethylhexyl methacrylate, n-octyl acrylate, n-octyl methacrylate, isooctyl acrylate, isooctyl methacrylate, decyl acrylate and decyl methacrylate, dodecyl acrylate, dodecyl methacrylate. Preferably used monomers of this group are n-butyl acrylate, sec-butyl acrylate, isobutyl acrylate and tert-butyl acrylate. Particularly effective sizes for paper are obtained, for example, if n-butyl acrylate and tert-butyl acrylate are used as monomer (b) in the emulsion polymerization. If at least two monomers from this group of monomers are used in the emulsion polymerization, they can be metered either separately from one another or as a mixture. The combination of monomers of group (b) which is used in the emulsion polymerization may comprise, for example, from 8 to 18% by weight of n-butyl acrylate and from 4 to 12% by weight of tert-butyl acrylate, the sum of (a), (b), (c), (d) and (e) being 100% by weight and being based on the total solids content.

Monomers of group (c) are olefins, preferably olefins having a terminal double bond. For example, all a olefins having 2 to 40 carbon atoms in the molecule are suitable, preferably C₄- to C₂₄-olefins, in particular C₄- to C₁₈-olefins.

Examples of olefins which have an ethylenically unsaturated double bond and which can be subjected to free radical copolymerization, are the alkenes, ethylene, propylene, n-but-1-ene, n-but-2-ene (cis- and trans-form) and 2-methylpropene (isobutene). Of these alkenes, n-but-1-ene and/or isobutene are preferably used. Of course, it is also possible to use mixtures of abovementioned alkenes or gas mixtures comprising them. C₄-cuts of a naphtha cracker, in particular the raffinate II cut (consisting of from 30 to 50% by weight of n-but-1-ene, from 30 to 50% by weight of n-but-2-ene, from 10 to 30% by weight of n-butane and <10% by weight of other compounds), can particularly advantageously be used.

Examples of olefins having up to 40 carbon atoms in the molecule are the following linear or cyclic alkenes: 2-methyl-1-butene, 3-methyl-1-butene, 3,3-dimethyl-2-isopropyl-1-butene, 2-methyl-2-butene, 3-methyl-2-butene, 1-pentene, 2-methyl-1-pentene, 3-methyl-1-pentene, 4-methyl-1-pentene, 2-pentene, 2-methyl-2-pentene, 3-methyl-2-pentene, 4-methyl-2-pentene, 2-ethyl-1-pentene, 3-ethyl-1-pentene, 4-ethyl-1-pentene, 2-ethyl-2-pentene, 3-ethyl-2-pentene, 4-ethyl-2-pentene, 2,4,4-trimethyl-1-pentene, 2,4,4-trimethyl-2-pentene, 3-ethyl-2-methyl-1-pentene, 3,4,4-trimethyl-2-pentene, 2-methyl-3-ethyl-2-pentene, 1-hexene, 2-methyl-1-hexene, 3-methyl-1-hexene, 4-methyl-1-hexene, 5-methyl-1-hexene, 2-hexene, 2-methyl-2-hexene, 3-methyl-2-hexene, 4-methyl-2-hexene, 5-methyl-2-hexene, 3-hexene, 2-methyl-3-hexene, 3-methyl-3-hexene, 4-methyl-3-hexene, 5-methyl-3-hexene, 2,2-dimethyl-3-hexene, 2,3-dimethyl-2-hexene, 2,5-dimethyl-3-hexene, 2,5-dimethyl-2-hexene, 3,4-dimethyl-1-hexene, 3,4-dimethyl-3-hexene, 5,5-dimethyl-2-hexene, 2,4-dimethyl-1-hexene, 1-heptene, 2-methyl-1-heptene, 3-methyl-1-heptene, 4-methyl-1-heptene, 5-methyl-1-heptene, 6-methyl-1-heptene, 2-heptene, 2-methyl-2-heptene, 3-methyl-2-heptene, 4-methyl-2-heptene, 5-methyl-2-heptene, 6-methyl-2-heptene, 3-heptene, 2-methyl-3-heptene, 3-methyl-3-heptene, 4-methyl-3-heptene, 5-methyl-3-heptene, 6-methyl-3-heptene, 6,6-dimethyl-1-heptene, 3,3-dimethyl-1-heptene, 3,6-dimethyl-1-heptene, 2,6-dimethyl-2-heptene, 2,3-dimethyl-2-heptene, 3,5-dimethyl-2-heptene, 4,5-dimethyl-2-heptene, 4,6-dimethyl-2-heptene, 4-ethyl-3-heptene, 2,6-dimethyl-3-heptene, 4,6-dimethyl-3-heptene, 2,5-dimethyl-4-heptene, 1-octene, 2-methyl-1-octene, 3-methyl-1-octene, 4-methyl-1-octene, 5-methyl-1-octene, 6-methyl-1-octene, 7-methyl-1-octene, 2-octene, 2-methyl-2-octene, 3-methyl-2-octene, 4-methyl-2-octene, 5-methyl-2-octene, 6-methyl-2-octene, 7-methyl-2-octene, 3-octene, 2-methyl-3-octene, 3-methyl-3-octene, 4-methyl-3-octene, 5-methyl-3-octene, 6-methyl-3-octene, 7-methyl-3-octene, 4-octene, 2-methyl-4-octene, 3-methyl-4-octene, 4-methyl-4-octene, 5-methyl-4-octene, 6-methyl-4-octene, 7-methyl-4-octene, 7,7-dimethyl-1-octene, 3,3-dimethyl-1-octene, 4,7-dimethyl-1-octene, 2,7-dimethyl-2-octene, 2,3-dimethyl-2-octene, 3,6-dimethyl-2-octene, 4,5-dimethyl-2-octene, 4,6-dimethyl-2-octene, 4,7-dimethyl-2-octene, 4-ethyl-3-octene, 2,7-dimethyl-3-octene, 4,7-dimethyl-3-octene, 2,5-dimethyl-4-octene, 1-nonene, 2-methyl-1-nonene, 3-methyl-1-nonene, 4-methyl-1-nonene, 5-methyl-1-nonene, 6-methyl-1-nonene, 7-methyl-1-nonene, 8-methyl-1-nonene, 2-nonene, 2-methyl-2-nonene, 3-methyl-2-nonene, 4-methyl-2-nonene, 5-methyl-2-nonene, 6-methyl-2-nonene, 7-methyl-2-nonene, 8-methyl-2-nonene, 3-nonene, 2-methyl-3-nonene, 3-methyl-3-nonene, 4-methyl-3-nonene, 5-methyl-3-nonene, 6-methyl-3-nonene, 7-methyl-3-nonene, 8-methyl-3-nonene, 4-nonene, 2-methyl-4-nonene, 3-methyl-4-nonene, 4-methyl-4-nonene, 5-methyl-4-nonene, 6-methyl-4-nonene, 7-methyl-4-nonene, 8-methyl-4-nonene, 4,8-dimethyl-1-nonene, 4,8-dimethyl-4-nonene, 2,8-dimethyl-4-nonene, 1-decene, 2-methyl-1-decene, 3-methyl-1-decene, 4-methyl-1-decene, 5-methyl-1-decene, 6-methyl-1-decene, 7-methyl-1-decene, 8-methyl-1-decene, 9-methyl-1-decene, 2-decene, 2-methyl-2-decene, 3-methyl-2-decene, 4-methyl-2-decene, 5-methyl-2-decene, 6-methyl-2-decene, 7-methyl-2-decene, 8-methyl-2-decene, 9-methyl-2-decene, 3-decene, 2-methyl-3-decene, 3-methyl-3-decene, 4-methyl-3-decene, 5-methyl-3-decene, 6-methyl-3-decene, 7-methyl-3-decene, 8-methyl-3-decene, 9-methyl-3-decene, 4-decene, 2-methyl-4-decene, 3-methyl-4-decene, 4-methyl-4-decene, 5-methyl-4-decene, 6-methyl-4-decene, 7-methyl-4-decene, 8-methyl-4-decene, 9-methyl-4-decene, 5-decene, 2-methyl-5-decene, 3-methyl-5-decene, 4-methyl-5-decene, 5-methyl-5-decene, 6-methyl-5-decene, 7-methyl-5-decene, 8-methyl-5-decene, 9-methyl-5-decene, 2,4-dimethyl-1-decene, 2,4-dimethyl-2-decene, 4,8-dimethyl-1-decene, 1-undecene, 2-methyl-1-undecene, 3-methyl-1-undecene, 4-methyl-1-undecene, 5-methyl-1-undecene, 6-methyl-1-undecene, 7-methyl-1-undecene, 8-methyl-1-undecene, 9-methyl-1-undecene, 10-methyl-1-undecene, 2-undecene, 2-methyl-2-undecene, 3-methyl-2-undecene, 4-methyl-2-undecene, 5-methyl-2-undecene, 6-methyl-2-undecene, 7-methyl-2-undecene, 8-methyl-2-undecene, 9-methyl-2-undecene, 10-methyl-2-undecene, 3-undecene, 2-methyl-3-undecene, 3-methyl-3-undecene, 4-methyl-3-undecene, 5-methyl-3-undecene, 6-methyl-3-undecene, 7-methyl-3-undecene, 8-methyl-3-undecene, 9-methyl-3-undecene, 10-methyl-3-undecene, 4-undecene, 2-methyl-4-undecene, 3-methyl-4-undecene, 4-methyl-4-undecene, 5-methyl-4-undecene, 6-methyl-4-undecene, 7-methyl-4-undecene, 8-methyl-4-undecene, 9-methyl-4-undecene, 10-methyl-4-undecene, 5-undecene, 2-methyl-5-undecene, 3-methyl-5-undecene, 4-methyl-5-undecene, 5-methyl-5-undecene, 6-methyl-5-undecene, 7-methyl-5-undecene, 8-methyl-5-undecene, 9-methyl-5-undecene, 10-methyl-5-undecene, 1-dodecene, 2-dodecene, 3-dodecene, 4-dodecene, 5-dodecene, 6-dodecene, 4,8-dimethyl-1-decene, 4-ethyl-1-decene, 6-ethyl-1-decene, 8-ethyl-1-decene, 2,5,8-trimethyl-1-nonene, 1-tridecene, 2-tridecene, 3-tridecene, 4-tridecene, 5-tridecene, 6-tridecene, 2-methyl-1-dodecene, 11-methyl-1-dodecene, 2,5-dimethyl-2-undecene, 6,10-dimethyl-1-undecene, 1-tetradecene, 2-tetradecene, 3-tetradecene, 4-tetradecene, 5-tetradecene, 6-tetradecene, 7-tetradecene, 2-methyl-1-tridecene, 2-ethyl-1-dodecene, 2,6,10-trimethyl-1-undecene, 2,6-dimethyl-2-dodecene, 11-methyl-1-tridecene, 9-methyl-1-tridecene, 7-methyl-1-tridecene, 8-ethyl-1-dodecene, 6-ethyl-1-dodecene, 4-ethyl-1-dodecene, 6-butyl-1-decene, 1-pentadecene, 2-pentadecene, 3-pentadecene, 4-pentadecene, 5-pentadecene, 6-pentadecene, 7-pentadecene, 2-methyl-1-tetradecene, 3,7,11-trimethyl-1-dodecene, 2,6,10-trimethyl-1-dodecene, 1-hexadecene, 2-hexadecene, 3-hexadecene, 4-hexadecene, 5-hexadecene, 6-hexadecene, 7-hexadecene, 8-hexadecene, 2-methyl-1-pentadecene, 3,7,11-trimethyl-1-tridecene, 4,8,12-trimethyl-1-tridecene, 11-methyl-1-pentadecene, 13-methyl-1-pentadecene, 7-methyl-1-pentadecene, 9-methyl-1-pentadecene, 12-ethyl-1-tetradecene, 8-ethyl-1-tetradecene, 4-ethyl-1-tetradecene, 8-butyl-1-dodecene, 6-butyl-1-dodecene, 1-heptadecene, 2-heptadecene, 3-heptadecene, 4-heptadecene, 5-heptadecene, 6-heptadecene, 7-heptadecene, 8-heptadecene, 2-methyl-1-hexadecene, 4,8,12-trimethyl-1-tetradecene, 1-octadecene, 2-octadecene, 3-octadecene, 4-octadecene, 5-octadecene, 6-octadecene, 7-octadecene, 8-octadecene, 9-octadecene, 2-methyl-1-heptadecene, 13-methyl-1-heptadecene, 10-butyl-1-tetradecene, 6-butyl-1-tetradecene, 8-butyl-1-tetradecene, 10-ethyl-1-hexadecene, 1-nonadecene, 2-nonadecene, 1-methyl-1-octadecene, 7,11,15-trimethyl-1-hexadecene, 1-eicosene, 2-eicosene, 2,6,10,14-tetramethyl-2-hexadecene, 3,7,11,15-tetramethyl-2-hexadecene, 2,7,11,15-tetramethyl-1-hedecene, 1-docosene, 2-docosene, 7-docosene, 4,9,13,17-tetramethyl-1-octadecene, 1-tetracosene, 2-tetracosene, 9-tetracosene, 1-hexacosene, 2-hexacosene, 9-hexacosene, 1-triacontene, 1-dotriacontene or 1-tritriacontene and the cyclic alkenes cyclopentene, 2-methyl-1-cyclopentene, 3-methyl-1-cyclopentene, 4-methyl-1-cyclopentene, 3-butyl-1-cyclopentene, vinylcyclopentane, cyclohexene, 2-methyl-1-cyclohexene, 3-methyl-1-cyclohexene, 4-methyl-1-cyclohexene, 1,4-dimethyl-1-cyclohexene, 3,3,5-trimethyl-1-cyclohexene, 4-cyclopentyl-1-cyclohexene, vinylcyclohexane, cycloheptene, 1,2-dimethyl-1-cycloheptene, cyclooctene, 2-methyl-1-cyclooctene, 3-methyl-1-cyclooctene, 4-methyl-1-cyclooctene, 5-methyl-1-cyclooctene, cyclononene, cyclodecene, cycloundecene, cyclododecene, bicyclo[2.2.1]hept-2-ene, 5-ethylbicyclo[2.2.1]hept-2-ene, 2-methylbicyclo[2.2.2]oct-2-ene, bicyclo[3.3.1]non-2-ene or bicyclo[3.2.2]non-6-ene.

Isobutene, diisobutene, 1-octene, 1-decene, 1-dodecene and mixtures of these olefins are particularly preferred. In the emulsion polymerization, only a single olefin or an olefin mixture can be used as monomer of group (c). The olefins are used, for example, in an amount of from 5 to 30% by weight, preferably from 10 to 20% by weight, the sum of (a), (b), (c), (d) and (e) being 100% by weight and being based on the solids content of the dispersion.

In principle, all monomers which are different from the monomers (a), (b) and (c) can be used as monomers of group (d). Examples of these are stearyl acrylate, stearyl methacrylate, palmityl acrylate, vinyl acetate, vinyl propionate, hydroxyethyl acrylate, hydroxyethyl methacrylate, N-vinylformamide, acrylamide, methacrylamide, N-vinylpyrrolidone, N-vinylimidazole, n-vinylcaprolactam, acrylic acid, methacrylic acid, acrylamidomethylpropanesulfonic acid, vinylsulfonic acid, styrenesulfonic acid and salts of the monomers comprising acid groups. The acidic monomers can be used in partly or in completely neutralized form. Neutralizing agents used are, for example, sodium hydroxide solution, potassium hydroxide solution, sodium carbonate, sodium bicarbonate, calcium hydroxide and ammonia.

Further examples of monomers (d) are dialkylaminoalkyl(meth)acrylates and dialkylaminoalkyl(meth)acrylamides, such as dimethylaminoethyl acrylate, dimethylaminoethyl methacrylate, diethylaminoethyl acrylate, diethylaminoethyl methacrylate, dimethylaminopropyl acrylate, dimethylaminopropyl methacrylate, dimethylaminoethyl acrylamide, dimethylaminoethyl methacrylamide, dimethylaminopropyl acrylamide and dimethylaminopropyl methacrylamide. The basic monomers can be used in the form of the free bases, as salts with organic acids or mineral acids or in quaternized form in the polymerization. The monomers of group (d) are present, for example, in an amount of from 0 to 10% by weight, in general from 0 to 5% by weight, in the reaction mixture comprising the components (a), (b), (c), (d) and (e).

From 0 to 3% by weight of at least one ethylenically unsaturated monomer having at least two double bonds in the molecule, so-called crosslinking agents, can also be used as monomers of group (d). If such compounds are concomitantly used in the copolymerization, the amount used is preferably from 0.05 to 2.0% by weight, based on the sum of the components (a), (b), (c), (d) and (e).

Examples of crosslinking agents are triallylamine, pentaerythrityl triallyl ether, methylenebisacrylamide, N,N′-divinylethyleneurea, allyl ethers comprising at least two allyl groups or vinyl ethers comprising at least two vinyl groups and derived from polyhydric alcohols, such as, for example, sorbitol, 1,2-ethanediol, 1,4-butanediol, trimethylolpropane, glycerol or diethylene glycol, and from sugars, such as sucrose, glucose or mannose, dihydric alcohols completely esterified with acrylic acid or methacrylic acid and having 2 to 4 carbon atoms, such as ethylene glycol dimethacrylate, ethylene glycol diacrylate, butanediol dimethacrylate, butanediol diacrylate, diacrylates or dimethacrylates of polyethylene glycols having molecular weights of from 100 to 600, ethoxylated trimethylenepropane triacrylates or ethoxylated trimethylenepropane trimethacrylates, 2,2-bis(hydroxymethyl)butanol trimethacrylate, pentaerythrityl triacrylate, pentaerythrityl tetraacrylate and triallylmethylammonium chloride. Preferably used crosslinking agents are allyl methacrylate, allyl acrylate, butanediol 1,4-diacrylate, butandiol 1,4-dimethacrylate, divinylbenzene or mixtures thereof.

The monomers (d) are used only for modifying the properties of the emulsion polymers. Polymer dispersions which are free of monomers of this group are preferred.

The polymerization of the monomers (a), (b), (c) and, if appropriate, (d) is effected in the presence of starch, in general in the presence of a degraded starch, which has, for example, a molar mass M_{w} of from 1000 to 65 000. The average molecular weights M_{w} of the degraded starches can readily be determined by methods known to the person skilled in the art, for example by means of gel permeation chromatography with the use of a multiangle light scattering detector.

Such a starch can be obtained starting from all starch types, for example from natural, anionic, cationic or amphoteric starch. The starch may originate, for example, from potatoes, corn, wheat, rice, tapioca or sorghum or may be a waxy starch which has an amylopectin content of >80, preferably >95, % by weight, such as waxy cornstarch or waxy potato starch. The starch may have been anionically and/or cationicaly modified, esterified, etherified and/or crosslinked. Cationized starches are preferred.

If the molecular weight M_{w} of the starches is not already in the range of from 1000 to 65 000, they are subjected to a decrease in molecular weight before the beginning of the polymerization, during the polymerization or in a separate step. The procedure in which the starch is enzymatically and/or oxidatively degraded before the beginning of the polymerization is preferred. The molar mass M_{w} of the degraded starch is preferably in the range from 2500 to 35 000.

The use of anionic or of cationic starch is particularly preferred. Such starches are known. Anionic starches are obtainable, for example, by oxidation of natural starches. Cationic starches are prepared, for example, by reacting natural starch with at least one quaternizing agent, such as 2,3-epoxipropyltrimethylammonium chloride. The cationized starches comprise quaternary ammonium groups. In the preparation of the finely divided polymer dispersions, a preferable procedure is one in which an anionic or cationic starch is enzymatically and/or oxidatively degraded before the beginning of the polymerization.

The proportion of cationic or anionic groups in substituted starch is stated with the aid of the degree of substitution (DS). It is, for example, from 0.005 to 1.0, preferably from 0.01 to 0.4.

The degradation of the starch is preferably effected before the polymerization of the monomers but can also be carried out during the polymerization of the monomers. It can be carried out oxidatively, thermally, acidolytically or enzymatically. The starch degradation is preferably effected enzymatically and/or oxidatively directly before the beginning of the emulsion polymerization in the apparatus in which the polymerization is to be carried out or in a separate step. It is possible to use a single degraded starch or mixtures of two or more degraded starches in the polymerization. The starch is present, for example, in an amount of from 15 to 35% by weight, preferably from 20 to 30% by weight, in the reaction mixture comprising the components (a), (b), (c), (d) and (e).

The invention also relates to a process for the preparation of finely divided, starch-containing polymer dispersions. In the process,
(a) from 30 to 60% by weight of at least one optionally substituted styrene, acrylonitrile and/or methacrylonitrile,
(b) from 5 to 50% by weight of at least one C₁-C₁₂-alkyl acrylate and/or one C₁-C₁₂-alkyl methacrylate,
(c) from 5 to 30% by weight of at least one olefin,
(d) from 0 to 10% by weight of at least one other ethylenically unsaturated copolymerizable monomer and
(e) from 15 to 35% by weight of a degraded starch,

the sum (a)+(b)+(c)+(d)+(e) being 100% and being based on the total solids content, are polymerized in an aqueous medium in the presence of a redox initiator.

The starch used as component (e) is preferably enzymatically and/or oxidatively degraded before the beginning of the polymerization. Anionic starch which was subjected to a decrease in molecular weight is preferably used as component (e). In the process for the preparation of the aqueous, starch-containing polymer dispersions, it has proven advantageous, after the end of the polymerization, to add a complexing agent to the polymer dispersion in an amount such that heavy metal ions present therein are complexed. Heavy metal ions generally originate from the redox initiator required for the polymerization.

A redox initiator is used for initiating the polymerization. Such redox initiators are preferably graft-linking, water-soluble redox systems, for example comprising hydrogen peroxide and a heavy metal salt or comprising hydrogen peroxide and sulfur dioxide or comprising hydrogen peroxide and sodium metabisulfite. Further suitable redox systems are combinations of tert-butyl hydroperoxide/sulfur dioxide, sodium or potassium persulfate/sodium bisulfite, ammonium persulfate/sodium bisulfite or ammonium persulfate/iron(II) sulfate. Hydrogen peroxide in combination with a heavy metal salt, such as iron(II) sulfate, is preferably used. Frequently, the redox system additionally comprises a further reducing agent, such as ascorbic acid, sodium formaldehyde sulfoxylate, sodium disulfite and/or sodium dithionite. Since the polymerization of the monomers is effected in the presence of starch and since starch likewise acts as a reducing agent, the concomitant use of further reducing agents is generally dispensed with. The redox initiators are used, for example, in an amount of from 0.05 to 5% by weight, preferably from 0.1 to 4% by weight, based on the monomers.

The emulsion polymerization of the monomers (a) to (c) and, if appropriate, (d) is effected in an aqueous medium in the presence of a starch (d). The polymerization can be carried out both in the feed process and by a batch process. Preferably, an aqueous solution of a degraded cationic starch and a heavy metal salt is initially taken and the monomers, either separately or as a mixture, and, separately therefrom, the oxidizing part of the redox initiator, preferably hydrogen peroxide, are added continuously or batchwise. A step or gradient procedure which is disclosed in WO-A-02/14393 can also be used for the preparation of the starch-containing polymer dispersions. There, the addition can be effected uniformly or non-uniformly, i.e. with changing metering rate, over the metering period.

According to a preferred embodiment, at least one monomer of group (c) and at least one degraded starch (e) are initially taken in an aqueous medium in the polymerization and the monomers of groups (a), (b) and, if appropriate (d) and at least one initiator are metered into the initially taken mixture under polymerization conditions. The polymerization is usually carried out in the absence of oxygen, preferably in an inert gas atmosphere, e.g. under nitrogen. During the polymerization, thorough mixing of the components should be ensured. Thus, the reaction mixture is preferably stirred during the entire duration of the polymerization and any postpolymerization thereafter.

The polymerization is usually carried out at temperatures of from 30 to 110° C., preferably at from 50 to 100° C. The use of a pressure reactor or carrying out a continuous polymerization in a stirred vessel cascade or a flow tube is also possible. If the polymerization mixture comprises low-boiling constituents which are gaseous at the polymerization temperature prevailing in each case, polymerization is effected under superatmospheric pressure, for example at pressures up to 50 bar, in general in the range from 1.5 to 25 bar.

To increase the dispersing effect, customary ionic, nonionic or amphoteric emulsifiers may be added to the polymerization batch. Customary emulsifiers are used only if appropriate. The amounts used are, for example, from 0 to 3% by weight and are preferably in the range of from 0.02 to 2% by weight, based on the sum of the monomers (a) to (c) used. Particularly preferably, however, the emulsion polymerization is carried out in the absence of an emulsifier. Customary emulsifiers are described in detail in the literature, cf. for example M. Ash, I. Ash, Handbook of Industrial Surfactants, Third Edition, Synapse Information Resources Inc. Examples of customary emulsifiers are the reaction products of long-chain monohydric alcohols (C₁₀- to C₂₂-alkanols) with from 4 to 50 mol of ethylene oxide and/or propylene oxide per mole of alcohol or ethoxylated phenols or alkoxylated alcohols esterified with sulfuric acid which are generally used in a form neutralized with alkali. Further customary emulsifiers are, for example, sodium alkanesulfonates, sodium alkylsulfates, sodium dodecylbenzenesulfonate, sulfosuccinic esters, quaternary alkylammonium salts, alkylbenzylammonium salts, such as dimethyl-C₁₂- to C₁₈-alkylbenzylammonium chlorides, primary, secondary and tertiary fatty amine salts, quaternary amidoamine compounds, alkylpyridinium salts, alkylimidazolinium salts and alkyloxazolinium salts.

During the emulsion polymerization, either the monomers can be metered directly into the initially taken mixture or they can be fed in the form of an aqueous emulsion or mini emulsion to the polymerization batch. For this purpose, the monomers are emulsified in water with the use of the abovementioned customary emulsifiers.

In addition to emulsifiers, protective colloids, which can be used alone or together with at least one emulsifier, are also suitable for stabilizing the polymer dispersion. Examples of protective colloids are polyvinyl pyrrolidone, polyvinyl alcohol, partly hydrolyzed polyvinyl acetate, graft polymers of vinyl acetate on polyalkylene glycols, such as, in particular, polyethylene glycol, polypropylene glycol and block copolymers of ethylene oxide and propylene oxide, graft polymers of N-vinylformamide on polyalkylene glycols, such as, in particular, polyethylene glycol, polypropylene glycol and hydrolysis products of these block copolymers, whose grafted-on vinylformamide groups have been partly or completely converted into amino groups, carboxymethylcellulose or polymers which comprise basic monomers, such as dialkylaminoalkyl (meth)acrylates, incorporated in the form of polymerized units, for example copolymers of acrylamide and dimethylaminoethyl acrylate, copolymers of acrylamide and diethylaminoethyl acrylamide, copolymers of acrylamide and dimethylaminopropylacrylamide, copolymers of acrylamide and dimethylaminoethylmethacrylamide and copolymers of acrylamide and diethylaminoethylmethacrylamide, polydiallyldimethylammonium chloride, polyvinylimidazole or copolymers of acrylamide and imidazoline. The basic monomers are preferably used in the form of the salts with a mineral acid or an organic acid or in quaternized form. Quaternizing agents are, for example, alkyl halides, such as methyl chloride, ethyl chloride, hexyl chloride, benzyl chloride or octyl chloride, and dimethyl sulfate and diethyl sulfate. The molar masses M_{w} of the protective colloids are, for example, in the range of from 1000 to 100 000, preferably from 1500 to 30 000. The protective colloids are used in the emulsion polymerization, for example, in amounts of from 0 to 10% by weight, based on the monomers used in the polymerization. It is possible to use a single protective colloid or a mixture of two or more protective colloids in the emulsion polymerization. If at least one protective colloid is used, the amounts are preferably from 1 to 5% by weight, based on the monomers.

The polymerization can, if appropriate, also be carried out in the presence of customary regulators. In principle, it is possible to use all known regulators which reduce the molecular weight of the resulting polymers, but preferably used regulators are organic compounds which comprise sulfur in bound form, for example mercaptans, di- and polysulfides, esters and sulfides of thio- and dithiocarboxylic acids and enol sulfides. Halogen compounds, aldehydes, ketones, formic acid, enol ethers, enamines, hydroxylamines, halogenated hydrocarbons, alcohols, ethylbenzene and xylene are also suitable as regulators.

Examples of regulators based on organic compounds which comprise sulfur in bound form are mercaptoethanol, mercaptopropanol, mercaptobutanol, thioglycolic acid, thioacetic acid, thiopropionic acid, thioethanolamine, sodium dimethyldithiocarbamate, cysteine, ethyl thioglycolate, trimethylolpropane trithioglycolate, pentaerythrityl tetra(mercaptopropionate), pentaerythrityl tetrathioglycolate, trimethylolpropane tri(mercaptoacetate), butyl methylenebisthioglycolate, thioglycerol, glyceryl monothioglycolate, n-octadecyl mercaptan, n-dodecyl mercaptan, tert-dodecyl mercaptan, butyl mercaptan, thiophenol, mercaptotrimethoxysilane and acetylcysteine.

Other suitable regulators are halogen compounds, such as trichloromethane, tetrachloromethane and bromotrichloromethane, aldehydes such as acetaldehyde, propionaldehyde, crotonaldehyde or butyraldehyde, alcohols such as n-propanol and isopropanol and buten-3-ol and allyl alcohol. Further suitable regulators are vitamin A acetate, vitamin A palmitate, geranial, neral, geraniol, geranyl acetate, limonene, linalyl acetate, terpinolene, γ-terpinene, α-terpinene, R(−)-α-phellandrene, terpineol, resorcinol, hydroquinone, pyrocatechol, phloroglucinol and diphenylethylene. Further examples of regulators based on terpinolene and unsaturated alicyclic hydrocarbons can be found, for example, in Winnacker-Küchler, Chemische Technologie, volume 6, pages 374 to 381, Carl Hanser Verlag, Munich, Vienna, 1982.

The amount of regulator is, for example, from 0 to 5, preferably from 0.1 to 2, % by weight, based on the monomers (a)-(c) and, if appropriate, (d).

The polymerization is carried out at a pH of from 2 to 9, preferably in the weakly acidic range at a pH of from 3 to 5.5. The pH can be adjusted to the desired value before or during the polymerization using customary acids, such as hydrochloric acid, sulfuric acid or acetic acid, or using bases, such as sodium hydroxide solution, potassium hydroxide solution, ammonia, ammonium carbonate, etc. The dispersion is preferably adjusted to a pH of from 5 to 7 after the end of the polymerization using sodium hydroxide solution, potassium hydroxide solution or ammonia.

In order to remove the remaining monomers as substantially as possible from the starch-containing polymer dispersion, a postpolymerization is expediently carried out after the end of the actual polymerization. For this purpose, an initiator from the group consisting of hydrogen peroxide, peroxides, hydroperoxides and/or azo initiators is added to the polymer dispersion after the end of the main polymerization. The combination of the initiators with suitable reducing agents, such as, for example, ascorbic acid or sodium bisulfite, is also possible. Oil-soluble initiators which are sparingly soluble in water are preferably used, for example customary organic peroxides, such as dibenzoyl peroxide, di-tert-butyl peroxide, tert-butyl hydroperoxide, cumyl hydroperoxide or biscyclohexyl peroxydicarbonates. For the postpolymerization, the reaction mixture is heated, for example, to a temperature which corresponds to the temperature at which the main polymerization was carried out or which is up to 20° C., preferably up to 10° C., higher. The main polymerization is complete when the polymerization initiator has been consumed or the monomer conversion is, for example, at least 98%, preferably at least 99.5%. Tert-butyl hydroperoxide is preferably used for the post polymerization. The polymerization is carried out, for example, in a temperature range of from 40 to 100° C., in general from 50 to 95° C.

After the end of the polymerization, a complexing agent for heavy metal ions can be added to the polymer dispersion in an amount such that all heavy metal ions are complexed. The starch-containing polymer dispersions comprise dispersed particles having a mean particle size of, for example, from 20 to 500 nm, preferably from 50 to 250 nm. The mean particle size can be determined by methods known to the person skilled in the art, such as, for example, laser correlation spectroscopy, ultracentrifuging or CHDF (Capillary Hydrodynamic Fractionation). A further measure of the particle size of the dispersed polymer particles is the LT value (value for the light transmittance). For determining the LT value, the polymer dispersion to be investigated in each case is measured in 0.1% strength by weight aqueous dilution in a cell having an edge length of 2.5 cm using light of 600 nm wavelength and is compared with the corresponding transmittance of water under the same measuring conditions. The transmittance of water is specified as 100%. The more finely divided the dispersion, the higher is the LT value which is measured by the method described above. From the measured values, it is possible to calculate the mean particle size, cf. B. Verner, M. Bárta, B. Sedlácek, Tables of Scattering Functions for Spherical Particles, Prague 1976, Edice Marco, Rada D-DATA, SVAZEK D-1.

The solids content of the starch-containing polymer dispersion is, for example, from 5 to 50% by weight and is preferably in the range of from 15 to 40% by weight.

The finely divided, aqueous, starch-containing polymer dispersions described above are used as sizes for paper, board and cardboard. They can be used both as surface sizes and as engine sizes in the amounts customary in each case. The use as surface size is preferred. The dispersions according to the invention can be processed by all processing methods suitable in the case of surface sizing. For the application, the dispersion is usually added to the size press liquor in an amount of from 0.05 to 5% by weight, based on solid substance, depending on the desired degree of sizing of the papers or paper products to be finished. Furthermore, the size press liquor may contain further substances, such as, for example, starch, pigments, optical brighteners, biocides, strength agents for paper, fixing agents, antifoams, retention aids and/or drainage aids. The size dispersion can be applied to paper, board or cardboard by means of a size press or other application units, such as a film press, Speedsizer or gate roll. The amount of polymer which is applied to the surface of paper products is, for example, from 0.005 to 1.0 g/m², preferably from 0.01 to 0.5 g/m².

Paper products which are sized with the finely divided, starch-containing polymer dispersions according to the invention have an improved degree of sizing, improved inkjet printability and toner adhesion compared with papers which have been sized with known sizes.

Unless evident otherwise from the context, the stated percentages in the examples are always percent by weight.

### EXAMPLES

### Example 1

Composition of the polymer: 37.16% of styrene, 13.57% of n-butyl acrylate, 8.57% of tert-butyl acrylate, 15% of 1-dodecene and 25.7% of starch

In a 21 four-necked flask which was equipped with an anchor stirrer, a reflux condenser and two metering apparatuses, 96.4 g of anionic starch (Amylex® 15 from Südstärke) were dispersed in 575 g of demineralized water and stirred under a nitrogen atmosphere. Thereafter, 1.3 g of a 25% strength by weight aqueous calcium acetate solution, 50 g of 1-dodecene and 5.2 g of a 2.5% strength by weight aqueous hydrogen peroxide solution were added and the mixture was heated to a temperature of 85° C. At this temperature, the addition of 2.4 g of a 1% strength aqueous solution of a commercially available α-amylase (Termamyl® 120 L from Novo Nordirsk) was effected. After a further 18 minutes, the enzymatic starch degradation was stopped by addition of 12.1 g of glacial acetic acid. In addition, 3.4 g of a 10% strength aqueous iron(II) sulfate solution (FeSO₄.7H₂O) were added and 4.6 g of a 2.5% strength aqueous hydrogen peroxide solution were run in uniformly with stirring in the course of 10 min. The reaction temperature was still kept at 85° C. A stirred mixture consisting of 162 g of demineralized water, 0.3 g of a 40% strength aqueous solution of a sodium alkanesulfonates (emulsifier K30 from Bayer AG) and 111.5 g of styrene, 40.7 g of n-butyl acrylate and 25.7 g of tert-butyl acrylate was then metered at a constant metering rate in the course of 90 min. Simultaneously with the metering of the emulsion feed, the separate initiator feed was started: 55.5 g of a 2.5% strength aqueous hydrogen peroxide solution was metered at a constant metering rate into the reaction mixture in the course of 120 min. After the end of the monomer feed, 57 g of demineralized water were added. After the end of the initiator feed, the reaction mixture was stirred for a further 60 min at 85° C.

After the polymerization, the reaction mixture was cooled to 65° C. and subjected to a postpolymerization. For this purpose, 6.3 g of a 10% strength aqueous tert-butyl hydroperoxide solution were added and the reaction mixture was stirred for a further 60 min at 65° C. Thereafter, it was cooled to room temperature, 31.4 g of a 25% strength sodium hydroxide solution were added, it was then stirred for 10 minutes and 3.2 g of formaldehyde and 1.2 g of Acticid® SPX were then added. After filtration through a sieve having a mesh size of 400 μm, a finely divided, aqueous dispersion having a solids content of 24.3% and a particle size of 83 nm (laser correlation spectroscopy) was obtained. The pH of the aqueous dispersion was 6.

### Example 2

Composition of the polymer: 37.16% of styrene, 8.57% of n-butyl acrylate, 18.57% of tert-butyl acrylate, 10% of 1-dodecene and 25.7% of starch

In a 2 l four-necked flask which was equipped with an anchor stirrer, a reflux condenser and two metering apparatuses, 96.4 g of anionic starch (Amylex® 15 from Südstärke) were dispersed in 575 g of demineralized water under a nitrogen atmosphere. The mixture was stirred, 1.3 g of a 25% strength aqueous calcium acetate solution, 31.6 g of 1-dodecene and 5.2 g of a 2.5% strength aqueous hydrogen peroxide solution were then added and the mixture was heated to a temperature of 85° C. At this temperature, the addition of 2.4 g of a 1% strength aqueous solution of a commercially available α-amylase (Termamyl® 120 L from Novo Nordirsk) was effected. After a further 18 minutes, the enzymatic starch degradation was stopped by addition of 12.1 g of glacial acetic acid. Thereafter, 3.4 g of a 10% strength aqueous iron(II) sulfate solution (FeSO₄.7H₂O) were added and 4.6 g of a 2.5% strength aqueous hydrogen peroxide solution were run in uniformly with stirring in the course of 10 min. The reaction temperature of 85° C. was still maintained. A stirred mixture consisting of 162 g of demineralized water, 0.3 g of a 40% strength aqueous solution of sodium alkanesulfonates (emulsifier K30 from Bayer AG) and 111.5 g of styrene, 25.7 g of n-butyl acrylate and 55.7 g of tert-butyl acrylate was then metered at a constant metering rate in the course of 90 min. Simultaneously with the metering of the emulsion feed, the separate initiator feed was started: 55.5 g of a 2.5% strength aqueous hydrogen peroxide solution were metered in into the reaction mixture at a constant metering rate in the course of 120 min. After the addition of monomers, 57 g of demineralized water were added. After the end of the initiator feed, reaction mixture was stirred for a further 60 min at 85° C. Thereafter, the reaction mixture was cooled to 65° C., 6.3 g of a 10% strength aqueous tert-butyl hydroperoxide solution were added for the postpolymerization and stirring was effected for a further 60 min at 65° C. Thereafter, it was cooled to room temperature, 31.4 g of a 25% strength sodium hydroxide solution were added, the mixture was stirred for 10 minutes and 3.2 g of formaldehyde and 1.2 g of Acticid® SPX were then added. After filtration (400 μm sieve), a finely divided dispersion having a solids content of 25% and a particle size of 84 nm (laser correlation spectroscopy) was obtained. The pH of the aqueous dispersion was 6.

### Example 3

Composition of the polymer: 37.16% of styrene, 3.57% of n-butyl acrylate, 18.57% of tert-butyl acrylate, 15% of 1-octene and 25.7% of starch

In a 2 l four-necked flask which was equipped with an anchor stirrer, a reflux condenser and two metering apparatuses, 96.4 g of anionic starch (Amylex® 15 from Südstärke) were dispersed in 575 g of demineralized water under a nitrogen atmosphere. The mixture was stirred, 1.3 g of a 25% strength aqueous calcium acetate solution, 45.5 g of 1-octene and 5.2 g of a 2.5% strength aqueous hydrogen peroxide solution were added and the mixture was heated to a temperature of 85° C. At 85° C. the addition of 2.4 g of a 1% strength aqueous solution of a commercially available α-amylase (Termamyl® 120 L from Novo Nordirsk) was then effected. After a further 18 minutes, the enzymatic starch degradation was stopped by adding 12.1 g of glacial acetic acid. Thereafter, 3.4 g of a 10% strength aqueous iron(II) sulfate solution (FeSO₄.7H₂O) were added and 4.6 g of a 2.5% strength aqueous hydrogen peroxide solution were then metered uniformly into the reaction mixture with stirring in the course of 10 min. The reaction temperature of 85° C. was still maintained. A stirred mixture consisting of 164 g of demineralized water, 0.3 g of a 40% strength aqueous solution of a sodium alkanesulfonate (emulsifier K30 from Bayer AG) and 111.5 g of styrene, 10.7 g of n-butyl acrylate and 55.7 g of tert-butyl acrylate was then metered at a constant metering rate in the course of 90 min. Simultaneously with the metering of the emulsion feed, the initiator feed was started separately therefrom by metering 55.5 g of a 2.5% strength aqueous hydrogen peroxide solution into the reaction mixture at a constant metering rate in the course of 120 min. After addition of the monomers, 57 g of demineralized water were added to the reaction mixture. After the end of the initiator feed, the reaction mixture was stirred for a further 60 min at 85° C. After the polymerization, the reaction mixture was cooled to 65° C., 6.3 g of a 10% strength aqueous tert-butyl hydroperoxide solution were added and the mixture was stirred for a further 60 min. Thereafter, the reaction mixture was cooled to room temperature, 31.4 g of a 25% strength sodium hydroxide solution were added, the mixture was stirred for 10 minutes and 3.2 g of formaldehyde and 1.2 g of Acticid® SPX were then added. After filtration (400 μm sieve), a finely divided, aqueous, starch-containing polymer dispersion having a solids content of 25% and a particle size of 78 nm (laser correlation spectroscopy) was obtained. The pH of the dispersion was 6.

### Comparative Example 1

### Comparative Example 1

### Corresponding to Example 3 According to EP-B-1 056 783

In a polymerization vessel which was equipped with stirrer, reflux condenser, jacket heating and metering apparatus, 29.1 g of an oxidatively degraded potato starch (Perfectamyl®A 4692 from Avebe) were dispersed in 234.7 g of demineralized water with stirring. The mixture was heated to 85° C. with stirring, and 10.0 g of a 1% strength aqueous solution of FeSO₄.7H₂O and 27.1 g of a 3% strength by weight aqueous hydrogen peroxide solution were added in succession. After stirring for 15 min at 85° C., the feeds of monomer and initiator were started simultaneously. Both a mixture consisting of 39.0 g of styrene, 16.0 g of n-butyl acrylate, 16.0 g of tert-butyl acrylate and 4.0 g of acrylic acid and, separately therefrom, 21.9 g of a 3% strength by weight aqueous hydrogen peroxide solution were metered in each case at a constant metering rate in the course of 90 min. After the end of the metering, the reaction mixture was stirred for a further 15 min at 85° C. and 0.3 g of tert-butyl hydroperoxide (70%) was then added for reactivation. After a further 60 min at 85° C., cooling to room temperature was effected and a pH of 6.5 was established with ammonia (25%). After filtration (100 μm), a finely divided dispersion having a solids content of 24.1% and an LT value (0.01%) of 88 and a particle size of 81 nm (laser correlation spectroscopy) was obtained.

### Comparative Example 2

### Corresponding to Example 5 of EP-B-1 056 783

Comparative example 1 was repeated, but a mixture of 37.5 g of styrene and 37.5 g of n-butyl acrylate was metered as monomer feed. 0.5 g of tert-butyl acrylate was used for reactivation. 3.3 g of NaOH (25%) were added for adjusting the dispersion to a pH of 6.5. After filtration (100 μm) a finely divided dispersion having a solids content of 24.0%, an LT value (0.01%) of 91 and a particle size of 69 nm (laser correlation spectroscopy) was obtained.

### Comparative Example 3

### Corresponding to EP-A-0 307 816

In a polymerization vessel which was equipped with stirrer, reflux condenser, jacket heating and metering apparatus, 31.1 g of an oxidatively degraded potato starch (Amylofax 15 from Avebe) in 199.5 g of demineralized water were initially taken under a nitrogen atmosphere and with stirring. The starch was dissolved with stirring by heating to 85° C. At this temperature, 5.6 g of glacial acetic acid, 0.05 g of iron(II) sulfate (FeSO₄.7H₂O) and 1.2 g of a 30% strength hydrogen peroxide solution were added in succession. After 20 minutes, a further 1.2 g of the 30% strength by weight hydrogen peroxide solution were added. A mixture consisting of 66 g of n-butyl acrylate, 58.5 g of styrene, 0.07 g of sodium lauryl sulfate, and 43.5 g of demineralized water was then metered in the course of 2 h. The initiator feed of 21 g of a 5.5% strength hydrogen peroxide solution began simultaneously and was likewise metered over 2 h at constant metering rate. After the end of the feeds, postpolymerization was effected for a further one hour at 85° C. After filtration (125 μm), a dispersion having a solids content of 33.9%, an LT (0.01%) of 86 and a particle size of 110 nm (laser correlation spectroscopy) was obtained.

### Use Examples

The starch-containing polymer dispersions described above were tested as sizes for paper according to the following test methods:

The determination of the degree of sizing was effected according to Cobb 60 according to DIN EN 20 535. The ink floatation time (IFT) was determined according to DIN 53 126 using a blue paper test ink. The toner adhesion was determined according to EN 12883 at a constant speed on an IGT tester.

Application of the starch-containing polymer dispersions in combination with starch to paper:

An oxidatively degraded, commercially available potato starch was brought into solution with heating to 95° C. for a defined time. The solids content of the starch solution was then adjusted to 8%. The polymer dispersion to be tested was stated in each case in the table below, was then added, in the concentrations likewise stated therein, to this starch solution. The mixture of starch solution and polymer dispersion was then applied at a temperature of 50° C. by means of a size press to a paper having a basis weight of 80 g/m², which had been lightly presized in the pulp with AKD (C₁₈-alkyldiketene). The preparation uptake was in the range of 40-45%. Thereafter, the papers thus treated were dried by means of contact drying at 90° C., conditioned for 24 h at 50% relative humidity and then subjected to the abovementioned tests. The results are stated in the table below.

TABLE

| | Cobb 60 | | IFT | | |
|---|---|---|---|---|---|
| Polymer dispersion | [g/m²] | | [min] | | Toner adhesion |
| prepared according to | 2 g/l | 4 g/l | 2 g/l | 4 g/l | [% ink density] |
| Example 1 | 32 | 23 | 18 | 45 | 89 |
| Example 2 | 35 | 24 | 12 | 32 | 78 |
| Example 3 | 39 | 26 | 7 | 23 | 81 |
| Comparative example 1 | 52 | 30 | 5 | 18 | 75 |
| Comparative example 2 | 35 | 26 | 5 | 15 | 63 |
| Comparative example 3 | 57 | 35 | 4 | 17 | 79 |

1. A finely divided, starch-containing polymer dispersion which is prepared by free radical emulsion copolymerization of ethylenically unsaturated monomers in the presence of at least one redox initiator and starch, wherein
(a) from 30 to 60% by weight of at least one optionally substituted styrene, acrylonitrile and/or methacrylonitrile,
(b) from 5 to 50% by weight of at least one C₁-C₁₂-alkyl acrylate and/or C₁-C₁₂-10alkyl methacrylate,
(c) from 5 to 30% by weight of at least one olefin,
(d) from 0 to 10% by weight of at least one other ethylenically unsaturated copolymerizable monomer and
(e) from 15 to 35% by weight of a degraded starch
are used as ethylenically unsaturated monomers, and
the sum (a)+(b)+(c)+(d)+(e) is 100% and is based on the total solids content.

2. A finely divided, starch-containing polymer dispersion which is prepared by free radical emulsion copolymerization of
(a) from 35 to 50% by weight of at least one optionally substituted styrene, acrylonitrile and/or methacrylonitrile,
(b) from 15 to 30% by weight of at least one C₁-C₁₂-alkyl acrylate and/or one C₁-C₁₂-alkyl methacrylate,
(c) from 10 to 20% by weight of a C₄- to C₂₄-olefin,
(d) from 0 to 5% by weight of at least one other ethylenically unsaturated copolymerizable monomer and
(e) from 20 to 30% by weight of a degraded anionic, cationic or amphoteric starch,
wherein the sum (a)+(b)+(c)+(d)+(e) is 100% and is based on the total solids content.

3. A finely divided, starch-containing polymer dispersion which is prepared by free radical emulsion copolymerization of
(a) from 35 to 50% by weight of styrene,
(b) from 15 to 30% by weight of at least one C₄-C₆-alkyl acrylate and/or one C₄-C₆-alkyl methacrylate,
(c) from 10 to 20% by weight of at least one C₄- to C₁₈-olefin, from 0 to 5% by weight of at least one other ethylenically unsaturated copolymerizable monomer and
(d) from 20 to 30% by weight of a degraded anionic, cationic, amphoteric or natural starch,
wherein the sum (a)+(b)+(c)+(d)+(e) is 100% and is based on the total solids content.

4. The finely divided, starch-containing polymer dispersion according to claim 1, wherein a degraded starch which has a molar mass M_{w} of from 1000 to 65 000 is used.

5. The finely divided, starch-containing polymer dispersion according to claim 1, wherein n-butyl acrylate and tert-butyl acrylate are used as monomer (b) in the emulsion polymerization.

6. The finely divided, starch-containing polymer dispersion according to claim 1, wherein from 0 to 3% by weight of at least one ethylenically unsaturated monomer having at least two double bonds in the molecule are used as the monomer of group (d).

7. A process for the preparation of finely divided, starch-containing dispersions according to claim 1, wherein
(a) from 30 to 60% by weight of at least one optionally substituted styrene, acrylonitrile and/or methacrylonitrile,
(b) from 5 to 50% by weight of at least one C1-C₁₂-alkyl acrylate and/or one C₁-C₁₂-alkyl methacrylate,
(c) from 5 to 30% by weight of at least one olefin,
(d) from 0 to 10% by weight of at least one other ethylenically unsaturated copolymerizable monomer and
(e) from 15 to 35% by weight of a degraded starch,
are polymerized in an aqueous medium in the presence of a redox initiator wherein the sum (a)+(b)+(c)+(d)+(e) is 100% and is based on the total solids content.

8. The process according to claim 7, wherein, in the polymerization, at least one monomer of group (c) and at least one degraded starch (e) are initially taken in an aqueous medium and the monomers of groups (a), (b) and, optionally, (d) and at least one initiator are metered into the initially taken mixture under polymerization conditions.

9. The process according to claim 7, wherein a cationic starch is enzymatically and/or oxidatively degraded before the beginning of the polymerization.

10. The process according to claim 7, wherein an anionic starch is enzymatically and/or oxidatively degraded before the beginning of the polymerization.

11. The process according to claim 7, wherein from 0 to 3% by weight of at least one ethylenically unsaturated monomer having at least two double bonds in the molecule are used as the monomer of group (d) in the emulsion polymerization.

12. The process according to claim 7, wherein an initiator from the group consisting of the peroxides, hydroperoxides, hydrogen peroxides and/or azo initiators is added to the polymer dispersion after the end of the main polymerization, and a postpolymerization is carried out.

13. The process according to claim 7, wherein a complexing agent is added after the end of the polymerization in an amount such that the heavy metal ions present therein are complexed.

14. A size for paper, board and cardboard comprising the finely divided, starch-containing polymer dispersion according to claim 1.
